(19) United States
(12) Patent Application Publication
(10) Pub. No.: US 2006/0165282 A1
(43) Pub. Date: Jul. 27, 2006

(54) Image segmentation

(76) Inventors: Robert-Paul Mario Berretty, Eindhoven (NL); Cornelius Wilhelmus Antonius Marie Van Overveld, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/560,632

(22) PCT Filed: Jun. 2, 2004
(86) PCT No.: PCT/IB04/50824

§ 371 Date: Dec. 13, 2005

(30) Foreign Application Priority Data
Jun. 16, 2003 (EP) 03101.747.8

(51) Int. Cl. G06K 9/34

(52) U.S. Cl. 382/173

(57) ABSTRACT

A image obtained by a camera is segmented into regions. Information about signs of curvature values of an intensity of the image is computed as a function of pixel location. Pixel locations are assigned to different segments, each according to one or more, or a combination of the signs for the pixel location. Preferably, each pixel location is assigned to a respective type of segment according to whether the signs of the curvature values in two mutually transverse directions at the pixel location are both positive or both negative respectively. Preferably spatial low pass filtering is used to control the number of segments that are found in this way.

The invention relates to image processing and in particular to image processing that involves segmentation of an image into regions of pixel locations with corresponding image properties.

Image segmentation involves grouping of pixel locations into variably selectable subsets of connected pixel locations, called segments, for which the pixel values have related properties. Ideally, each segment corresponds to a set of pixels where one object, or a visually distinguishable part of an object, is visible in the image. Image segmentation can be used for various purposes. In image compression apparatuses, for example, segmentation can be used to identify different regions of pixel locations whose content will be encoded at least partly by common information such as a common motion vector. As another example, in an apparatus that constructs an image of a scene from a user selectable viewpoint on the basis images from different viewpoints, image segmentation can be used to find candidate pixel regions that image the same object or background in different images.

Conventionally, two types of segmentation are known: edge based segmentation and core based segmentation. In edge based segmentation segments are defined by edges between segments after detecting the edges from the an image. Edges are detected for example by taking the Laplacian of image intensity (the sum of the second order derivative of the intensity with respect to x position and the second order derivative of the intensity with respect to y position) and designating pixel locations where this derivative exceeds a threshold value as edge locations. Subsequently a region surrounded by these edge locations is identified as a segment.

Core based segmentation conventionally involves comparing pixel values (or quantities computed from pixel values) at each pixel location with a threshold that distinguishes between in and out of segment values. Thus, for example, pixels in light regions of an image can be distinguished from a dark background.

In both cases the threshold has to be selected on the basis of a compromise. Setting the threshold too low makes segmentation susceptible to noise, so that segments are identified that do not persist from one image to another, because they do not correspond to real objects. Setting the threshold too high may have the effect of missing objects altogether.

As a result the prior art has sought for ways of selecting thresholds values that on one hand suppress noise effects and on the other hand do not make objects invisible. Threshold values have been selected adaptively, on the basis of statistical information about the observed pixel values in the image, to achieve optimal distinctions for a give image. For example, thresholds have been selected on the basis of histograms of the frequency of occurrence of pixel values in the image, between peaks in the histogram that are assumed to be due to objects and background respectively. Other techniques include using median values as threshold.

No need to say that the use of such statistical techniques to select thresholds for individual images, or even as a function of position in individual images represent a considerable overhead compared to the basic thresholding operation.

Nevertheless threshold selection remains a source of error, because it ignores coherence between pixel values. Conventional techniques have sought to compensate for this by including a “growing” step after thresholding, in which pixel locations adjacent to locations that have been grouped into a segment are joined to that segment. As a result the segment depends on the sequence in which the pixels are processed. An object in the image may be missed altogether if an insufficient number of its pixel locations is identified as belonging to the same segment. As a result threshold errors that appear to be small for pixels individually can accumulate to a large error that misses an object altogether.

Among others, it is an object of the invention to provide for a core based image segmentation technique that leads to reliable segmentation results but does not require variable threshold selection.

The invention provides for a method according to claim 1. According to the invention the sign of curvature values of an image intensity at a pixel location is used to identify the type of segment to which the pixel location belongs. Although image intensities only assume nonnegative values, the curvature of their dependence on position can assume both positive and negative values. As a result a fixed threshold value of zero curvature can be used to distinguish regions. Curvature is defined by the eigenvalues of a matrix of second order partial derivatives of the image intensity as a function of pixel location, but the eigenvalues need not always be computed explicitly to determine the signs.

The signs of curvature of the luminance as a function of pixel location may be used for example, but other intensities, such as intensities of color components may be used instead or in combination.

In an embodiment a pixel location is assigned to different types of region according to whether the curvature values at the pixel location are both positive or both negative. This provides a robust way of segmenting. In a further embodiment a combination of signs of curvature of a plurality of different intensities (for example intensities of different color components) is used to assign pixel locations to segments. Thus, more than two different types of segment can be distinguished.

In an embodiment the intensity is low pass filtered and the sign of the curvatures is determined after filtering. In this way the effect of noise can be reduced without having to select an intensity threshold. The differentiation involved in curvature determination is preferably an inherent part of filtering. In a further embodiment the bandwidth is set adaptive to image content, for example so as to regulate the number of separate regions, or the size (for example the average size) of the regions.

In another embodiment segments that are initially determined by assigning pixel locations to segments on the basis of sign of curvature are subsequently grown. Growing is preferably conditioned on the amplitude of the curvature, for example by joining pixel locations with small positive or negative curvature to adjacent segments on condition that the absolute value of the curvature is below a threshold, or by stopping growing when the absolute value is above a threshold.

These and other objects and advantageous aspects of the invention will be described using the following figures.

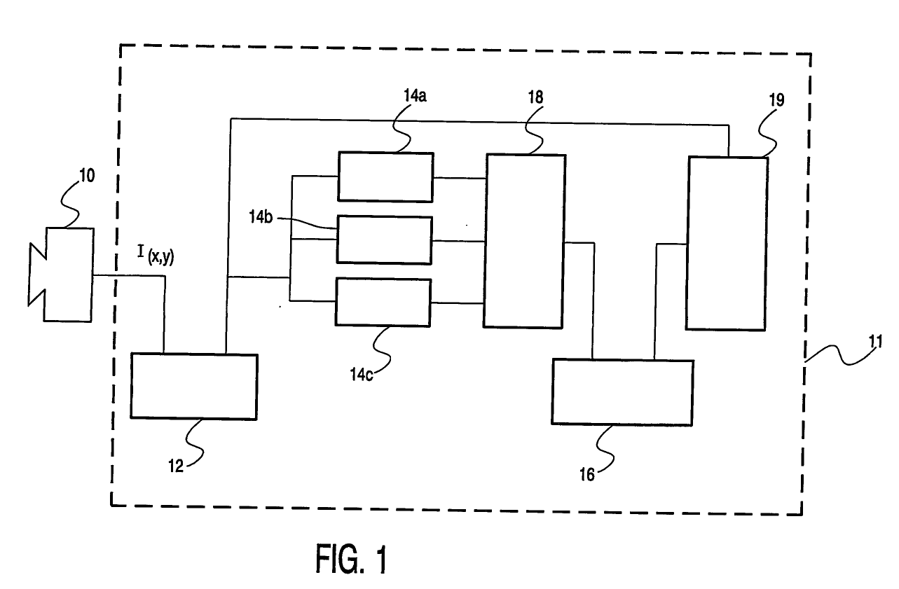

FIG. 1 shows an image processing system

FIG. 1 shows an image processing system that contains an image source 10 (for example a camera) and an image processing apparatus 11, with a first image memory 12, a plurality of filter units 14a-c, a second image memory 16, a segmentation unit 18 and a processing unit 19. Image source 10 has an output coupled to first image memory 12, which is coupled to the filter units 14a-d. Filter units 14a-d have outputs coupled to segmentation unit 18. Segmentation unit 18 is coupled to second image memory 16. Processing unit 19 is coupled to first image memory 12 and to segmentation unit 18 via second image memory 16. In operation, image source 10 captures an image and forms an image signal that represents an intensity I(x,y) of the captured image as a function of pixel location (x,y). The image is stored in first memory 12. Segmentation unit 18 identifies groups of pixel locations in the image as segments and stores information that identifies the pixel locations in the segments in second memory 16. Image processing unit 19 uses the information about the segments in the image to process the image, for example during a computation of compressed image signal for storage or transmission purposes or to construct a displayable image signal from a combination of images from image source 10.

Filter units 14a-c each perform a combination of low pass filtering of the intensity I(x,y) and taking a second order derivative of the low pass filtered version of the intensity I(x,y). Each filter unit 14a-c determines a different second order derivative from the set that includes the second derivative with respect to position along an x direction, the second derivative with respect to position along a y-direction and a cross derivative with respect to position along the x and y direction. Expressed in terms of a basic filter kernel G(x,y) the filter kernels of the respective filter units 14a-c are defined by
Gₓₓ(x,y)=∂²G(x,y)/∂x²
G_{yy}(x,y)=∂²G(x,y)/∂y²
G_{xy}(x,y)=∂²G(x,y)/∂x∂y
Filter units 14a,c compute images Ixx, Iyy, Ixy corresponding to
Iₓₓ(x,y)=∫dx′dy′Gₓₓ(x-x′,y-y′)I(x′,y′)
I_{yy}(x,y)=∫dx′dy′G_{y,y}(x-x′,y-y′)I(x′,y′)
I_{xy}(x,y)=∫dx′dy′G_{xy}(x-x′,y-y′)I(x′,y′)
For the sake of clarity these filter operations have been formulated in terms of integrals, although of course the intensity is usually sampled at discrete pixel locations (x,y). Therefore, filter units 14a-c normally compute sums corresponding to the integrals. The derivative filtered images Iₓₓ(x,y),I_{yy}(x,y) and I_{xy}(x,y) define a matrix
Iₓₓ(x,y)I_{xy}(x,y)
I_{xy}(x,y)I_{yy}(x,y)
For each pixel location x,y. The eigenvalues of this matrix define the curvature of the intensity I(x,y) at the location (x,y) after filtering.

Segmentation unit 18 uses a combination of the signs of the eigenvalues to segment the image. In one embodiment pixel locations where both eigenvalues are positive are assigned to segments of a first type and pixel locations where both eigenvalues are negative are assigned to segments of a second type. It is not necessary to compute the eigenvalues explicitly to determine the signs. The determinant of the matrix
D(x,y)=Iₓₓ(x,y)I_{yy}(x,y)−I²_{xy}(x,y)
equals the product of the eigenvalues. The trace
T(x,y)=Iₓₓ(x,y)+I_{yy}(x,y)
equals the sum of the eigenvalues. Hence it can be determined that both eigenvalues are positive at a pixel location by detecting that both the determinant and the trace for that pixel location are positive and and it can be detected that both eigenvalues are negative for a pixel location when the determinant is positive and the trace is negative for that location. Segmentation unit 18 initially determines for each individual pixel locations whether it belongs to a first type of segment, to a second type of segment or to neither of these types. Next, segmentation unit forms groups of pixels locations that are neigbors of one another and belong to the same type of segment. Each group corresponds to a segment. Segmentation unit 18 signals to processing unit 19 which pixel locations belong to the same segment. This may be done for example by using different image mapped memory locations in second memory 16 for different pixels location and writing label values that identify different regions to which the pixel locations belong into the different locations. In another embodiment segmentation unit does not identify the regions individually, but only writes information into memory locations to identifies the type of region to which the associated pixel location belongs. It should be appreciated that, instead of storing information for all pixel locations information may be stored for a subsampled subset of pixel locations, or in a non memory mapped form, such as boundary descriptions of different segments.

Processing unit 19 uses the information about the segments. The invention is not limited to a particular use. As an example processing unit 19 may use segments of the same type that have been found in different images in a search for corresponding regions in different images. When a first segment occurs in a first image and a second segment of the same type occurs in a second image processing unit 19 checks whether the content of the first and second images matches in or around the segments. If so, this can be used to compress the images, by coding the matching region in one image with a motion vector relative to the other. The motion vectors may be applied to encoding using the MPEG standard for example (the MPEG standard is silent on how motion vectors should be determined). An alternative use could be the determination of the distance of an object to the camera from the amount of movement. The segments may also be used for image recognition purposes. In an embodiment segments of one type only are selected for matching, but in another embodiment all types of segment are used.

Processing efficiency of processing unit 19 is considerably increased by using segments with similar curvature to select regions for determining whether the image content matches and by avoiding such selection if there are no segments with curvature does not match. The sign of the curvature is a robust parameter for selecting segments, because it is invariant under many image deformations, such as rotations, translations etc. Also, many gradual changes of illumination leave the signs of curvature invariant, since the signs of curvature of in an image region that images an object are strongly dependent on the intrinsic three-dimensional shape of the object.

Although the operation of segmentation unit 18 has been described in terms of a one to one relation between detected sign of the curvatures and assignment to a segment However, without deviating from the invention segmentation unit 18 may apply a growing operation to determine the segment, joining pixel locations that are adjacent to a segment but have not been assigned to the segment to that segment and merging segments that become adjacent in this way. Growing may be repeated iteratively until segments of opposite type meet one another. In an alternative embodiment growing may be repeated until the segments reach pixel locations where edges have been detected in the image.

Growing segments is known per se, but according to the invention the sign of the curvatures is used to make an initial segment selection. An implementation of growing involves first writing initial segment type identifications into image mapped memory locations in second memory 16 according to the sign of curvature for the pixel locations, and subsequently changing these type identifications according to the growing operation, for example by writing the type identification of pixel locations of an adjacent segment into a memory location for a pixel location that is joined to that segment.

The opposite of growing, shrinking, may be used as well, for example to remove irregularities on the edges of the selected segments.

In an embodiment segmentation unit conditions growing on the amplitude of the detected curvatures. In this embodiment pixel locations for which the curvatures have a sign opposite to that of an adjacent segment are joined to that segment when the one or more of the amplitudes of the curvatures for the pixel location are below a first threshold and one or more of the curvatures for the segment are above a second threshold. The thresholds may have predetermined values, or may be selected relative to one another.

As described segmentation unit 18 preferably distinguishes two types of initial segment, with pixel locations that have positive-positive or negative-negative curvature values respectively. However, different types of segment types may be used, for example with pixel locations where the in absolute sense largest curvature values are positive and negative respectively

Furthermore, curvature of luminance information as a function of pixel location is preferably used to select the regions, in other embodiments one may of course also use the intensity of other image components, such as color components R, G or B or U or V, or combinations thereof (the R, G, B, U and V components have standard definitions). In a further embodiment curvatures are determined for a plurality of different components and the combination of the signs of the curvatures for different components is used to segment the image. Thus, more than two different types of segments may be distinguished, or different criteria for selecting segments may be used. For example, in case of curvatures of R, G and B, three pieces of sign information may be computed, encoding for the R, G and B component respectively, whether the curvatures of the relevant component are both positive, both negative or otherwise. These three pieces of sign information may be used to distinguish eight types of segments (R, G and B curvatures all both positive, R and G curvatures all both positive and B curvatures both negative, etc.). These eight types may be used to segment the image into eight types of segments. Thus a more selective preselection of regions for matching by processing unit 19 is made possible.

A smaller number of types may also be used, for example a first type where at least two of the R, G and B components have all positive curvatures and a second type where at least two of the R, G and B components have all negative curvatures In a preferred embodiment filter units 14a-c use a Gaussian kernel G(x,y).
G(x,y)=exp(−(x²+y²)/2σ²)

This type of Kernel has the advantage that it can be implemented in filter units 14a-c as a cascade of two one-dimensional filter operations.

In an embodiment the filter scale (σ in case of Gaussian filters) is selected adaptive to image content. In one example segmentation unit 18 compares the number of initially determined regions with a target number and increases or decreases the scale when the number of initially determined regions is above or below the target number respectively. Instead of a single target value a pair of target values may be used, the scale being increased when the number of initially determined regions is above an upper threshold and decreased when that number is below a lower threshold. Thus, noise effects can be reduced without having to select an intensity threshold. As an alternative, the average size of the regions may be used instead of the number of regions to control adaptation of the scale.

The various units shown in FIG. 1 may be implemented for example in a suitably programmed computer, or digital signal processor unit that is programmed or hardwired to perform the required operations, such as filtering, sign of curvature computation, initial assignment to segments on the basis of the signs of curvature and segment growing. Instead of programmable processors dedicated processing units may be used, which may process the image intensity as a digital or analog signal or a combination of both. Combinations of these different types of hardware may be used as well.

1. An image processing method comprising segmentation of an image, said segmentation comprising the steps of
computing, for respective pixel locations in the image, information about signs of curvature values of an intensity of the image as a function of pixel location;
assigning pixel locations to different segments, each according to one or more, or a combination of the signs for the pixel location.

2. An image processing method according to claim 1, comprising
assigning each pixel location to respective different type of segments according to whether the signs of the curvature values in two mutually transverse directions at the pixel location are both positive or both negative respectively.

3. An image processing method according to claim 1, comprising spatially low pass filtering the intensity prior to said computing and computing the information about the sign of curvature from the low pass filtered intensity.

4. An image processing method according to claim 3, comprising selecting a bandwidth of said low pass filtering adaptive to a content of the image.

5. An image processing method according to claim 1, comprising growing the segments initially determined by said assigning, wherein said growing is conditioned on an amplitude of the curvature values.

6. An image processing apparatus, comprising
a sign of curvature computation unit (14a-c, 18) arranged to compute, for respective pixel locations, information about signs of curvature values of an intensity of the image as a function of pixel location;
a segmentation unit (18), arranged to assign pixel locations to different segments each according to one or more, or a combination of the signs for the pixel location.

7. An image processing apparatus according to claim 6, wherein the segmentation unit (18) is arranged to assign each pixel location to respective different types of segment when the signs of the curvature values in two mutually transverse directions at the pixel location are both positive or both negative respectively.

8. An image processing apparatus according to claim 6, comprising a spatial low pass filter unit (14a-c), for filtering the intensity prior to said computation of the information about the sign.

9. An image processing apparatus according to claim 8, comprising a feedback loop for selecting a bandwidth of said low pass filtering adaptive to a count of selected segments.

10. An image processing apparatus according to claim 8, comprising a feedback loop for selecting a bandwidth of said low pass filtering adaptive to a size of selected segments.

11. An image processing apparatus according to claim 6, wherein the segmentation unit is arranged to grow the segments initially determined by said assigning, wherein said growing is conditioned on an amplitude of the curvature values.
